(19) United States
(12) Patent Application Publication
(10) Pub. No.: US 2006/0148448 A1
(43) Pub. Date: Jul. 6, 2006

(54) Communication systems and methods

(75) Inventor: Simon R. Turner, Redhill (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/544,195

(22) PCT Filed: Jan. 30, 2004
(86) PCT No.: PCT/IB04/00267

§ 371 Date: Aug. 2, 2005

(30) Foreign Application Priority Data
Feb. 5, 2003 (GB) 0302590.5

(51) Int. Cl. H04M 3/16

(52) U.S. Cl. 455/410

(57) ABSTRACT

A communication system includes a receiver for receiving an audio signal. The audio signal includes an embedded telephone number, and the system includes an output device for outputting the embedded telephone number. In a first embodiment, the output device is a short-range wireless transceiver, such as Bluetooth transceiver. In this embodiment, the receiver is a digital television receiver and the output device is a separate unit connected to the SCART socket of the receiver.

This invention relates to communication systems and methods. In particular it relates to the transmission and receipt of an audio signal. This audio signal may be part of a larger broadcast signal that includes a video signal such as a television broadcast, or may be a simple audio signal such as a radio broadcast.

It is commonplace during the broadcast of television or radio programmes to mention associated telephone numbers. Traditionally this served the purpose of allowing the viewer or listener to access or give further information about the content being received. For example, during the broadcast of police information style programmes, a presenter would give out a telephone number for viewers to call if they had relevant information. Usually this would be simultaneously shown on the screen as an onscreen graphic.

In more recent times telephone numbers have been used for the purpose of voting in entertainment and more serious programmes. For example, a number of television programmes have been broadcast that allow the winner or successful contestant to be chosen by the viewing public, on the basis of telephone votes. Examples of such programmes include Big Brother and Popstars. At the critical time in the broadcast of the programme, the presenter will give a list of numbers each corresponding to an individual contestant, and the user can vote by dialling the correct number. In addition to standard telephone numbers, it is now common to also use shortened numbers that can be accessed by sending a text message from a mobile phone to the appropriate number. Throughout this application the term telephone number is used to designate both standard dialled numbers and the shortened numbers accessed by texting.

However all of the known systems have the weakness that the viewer or listener must correctly note down the telephone number used in the programme. This is particularly acute during radio programmes, which rely on the listener accurately hearing the entire number without any visual confirmation. This can lead to the viewer or listener being unable to obtain the telephone number, or worse, noting down the wrong number. This later problem can lead to nuisance calls to completely random telephone numbers or if the numbers are used for voting, a viewer may end up unintentionally voting for the wrong contestant.

It is therefore an object of the invention to improve upon the known prior art.

According to the first aspect of the invention, there is provided a communication system comprising a receiver for receiving an audio signal, said audio signal including an embedded telephone number, and an output device for outputting said embedded telephone number.

According to the second aspect of the invention, there is provided a communication method comprising receiving an audio signal, said audio signal including an embedded telephone number, and outputting said embedded telephone number

According to the third aspect of the invention, there is provided a communication system comprising a multiplexer for receiving an audio signal and for embedding a telephone number in said audio signal, and a transmitter for transmitting said audio signal.

According to the fourth aspect of the invention, there is provided a Communication method comprising multiplexing a received audio signal, embedding a telephone number in said audio signal, and transmitting said audio signal.

Owing to the invention, it is possible to deliver a telephone number to a viewer or listener to a broadcast that does not require the recipient to note down the number, thereby eliminating the possibility for errors of transcription to be made. It is also an advantage of the invention that the system is backwards compatible with legacy television and radio equipment.

In a first embodiment, the output device is a short-range wireless transceiver, and the receiver is a digital television receiver with the output device being a separate unit connected to the SCART socket of the receiver. Preferably the system further comprises a mobile device for receiving the embedded telephone number from the output device, the mobile device including a short-range wireless transceiver.

In a second embodiment, the output device is an audio transmitter. This is particularly advantageous when the receiver is a radio.

Advantageously, in the method of using the system includes retrieving the embedded telephone number from the audio signal. The method may further comprise storing the embedded telephone number and outputting the embedded telephone number on receipt of a predefined signal. This allows prior broadcast of the relevant information that is then stored locally and outputted when needed.

The audio signal can include multiple embedded telephone numbers and the outputting comprises outputting those multiple embedded telephone numbers. This provides for the situation when multiple numbers are used, for example during a voting style use of telephone numbers.

Embodiments of the invention will now be described, by way of example only, with reference to the accompanying drawings, in which:—

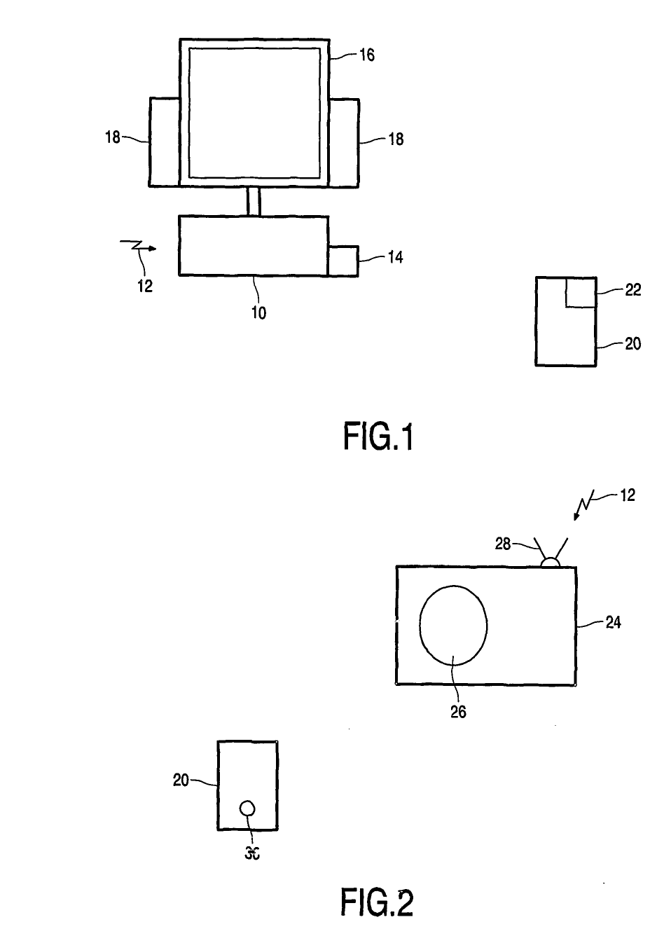

FIG. 1 is a schematic diagram of a communication system,

FIG. 2 is a schematic diagram of a second embodiment of the communication system,

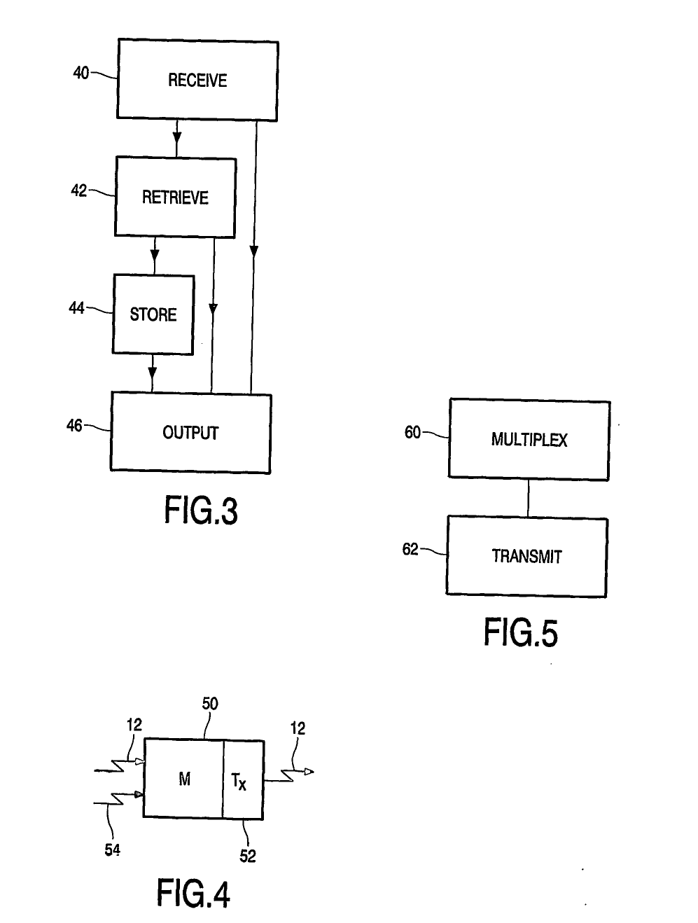

FIG. 3 is a flow diagram of a communication method, showing the operation of the communication systems of FIGS. 1 and 2,

FIG. 4 is a schematic diagram of a multiplexing and transmitting device, and

FIG. 5 is a flow diagram of a method of operation of the device of FIG. 4.

The communication system of FIG. 1 comprises a receiver 10 for receiving an audio signal 12. The audio signal 12 is shown schematically in the Figure, typically the audio signal 12 would be part of a larger digital television signal broadcast, received by the receiver 10 via a fixed line connection from an aerial or satellite dish. The audio signal 12 includes an embedded telephone number and the system further comprises an output device 14 for outputting the embedded telephone number.

The receiver 10 is a digital television receiver 10, commonly referred to as a set top box and the output device 14 is a separate unit connected to the SCART socket of the receiver 10. The output device 14 is a separate unit that a user would purchase to be able to access the improved system for receiving telephone numbers, and is in the form of a short-range wireless transceiver 14.

In a typical operation of the system, a user watches a television programme on the display 16 with the associated audio being outputted by speakers 18. If the programme contains an option to call a telephone number, for example, for the purpose of voting, then this number is embedded by the broadcaster in the audio signal. When the signal is received by the receiver 10, in addition to the audio signal being passed to the speakers 18, the receiver 10 also routes the audio signal through the output device 14. The device 14 can recognise the presence of the embedded telephone number within the audio signal and retrieves the embedded telephone number from the audio signal.

The device 14 then broadcasts the telephone number locally for reception by any suitable receiver. Any well-known short-range wireless protocol can be used, for example, Bluetooth or WiFi would be suitable protocols. If Bluetooth is used, then the telephone number is fed with suitable packet headers to a Bluetooth beacon (which forms part of the output device 14). The beacon searches the surroundings of the receiver 10 looking for a suitably enabled mobile phone. If successful, a standard communications dialogue is opened, and the number transferred to the screen of the mobile phone where it is now available at a single keystroke to complete the call via the mobile network.

In this embodiment, the system further comprises a mobile device 20, in the form of a mobile phone, for receiving the embedded telephone number from the output device 14. The mobile device includes a short-range wireless transceiver 22 for receiving the locally transmitted telephone number, which at this point is available to the user. The user can store the number in the mobile device 20, according to its own functionality, or can call the received telephone number straight away. Obviously if there is more than one mobile device 20 within range of the output device 14, then each device 20 will receive the number as per the operation of the protocol being used.

The audio signal 12 can include multiple embedded telephone numbers and the outputting comprises outputting the multiple telephone numbers. This situation commonly occurs in television programmes that have telephone voting as a feature of the broadcast. For example, the viewers can vote to choose which of a number of contestants they wish to be the winner. The different telephone numbers are embedded in the audio signal 12, possibly with further information embedded that relates to each number.

As before, the outputting device 14 receives the audio signal 12 and retrieves the telephone numbers and the additional information (if any is transmitted) and then broadcasts this locally on the short-range wireless system. Any mobile devices 20 within range will receive the numbers via their respective wireless transceiver 22 and each mobile device 20 can display the received telephone numbers. If any additional information is transmitted then this can also be displayed, as long as the mobile device 20 has the necessary functionality. For example, the additional information may be the names of the contestants that are to be voted on; this facilitates the user correctly selecting the phone number that corresponds to the individual that they wish to vote for. Again, the user can save the numbers if desired.

Owing to limitations on the data rate achievable in an embedding system, if a large number of telephone numbers and/or a large amount of additional information is to be embedded in the audio signal, then there exists the facility to store the embedded telephone numbers and output the embedded numbers on receipt of a predefined signal. This can also be used with just one embedded telephone number if that number is to be used several times during the programme being broadcast.

In this mode of operation, the output device 14, when retrieving the embedded telephone numbers and further information, can read a header from the data that indicates that the information received is to be stored. The device 14 then stores this information locally, in for example, a flash memory, and awaits the signal to broadcast via the wireless link. Upon receipt of the predefined signal, also embedded in the audio signal, the outputting device 14 broadcasts the telephone numbers locally via its wireless link along with any additional information. In this way, the telephone numbers that are to be broadcast from the outputting device 14 are synchronised with the part of the television programme that presents the telephone numbers to the user. The broadcaster can preprogram the timing of the predefined signal that triggers the broadcast from the output device 14, or this can be sent in real time, with, for example, the producer of a live television programme selecting the moment in the broadcast that the predefined signal is sent.

A second embodiment of the system is shown in FIG. 2. In this embodiment, the receiver for receiving the audio signal 12 is a radio 24, which receives the audio signal in a radio broadcast via its aerial 28. As before, the audio signal includes an embedded telephone number and the output device for outputting the embedded telephone number is an audio transmitter 26. In the system, a mobile device 20 is provided for receiving the embedded telephone number from the output device 26. The mobile device 20, in this example, is a mobile phone 20, which is provided with a microphone 30. The microphone, in addition to its standard operation of receiving the voice signal from a user of the phone 20, is also receiving the audio output of the radio 24 from the speaker 26.

During the operation of the second embodiment of the system, the radio 24 is effectively passive to the presence of the embedded telephone number within the audio signal 12. The radio simply operates in its normal manner, receiving the broadcast to which it is tuned and feeding the received audio signal 12 to the audio transmitter 26. Any devices that are within range of this broadcast, such as the mobile device 20, can receive this audio output. As long as the device 20 is provided with the correct software for detecting the presence of the embedded telephone numbers, then the device 20 can itself retrieve the embedded number from the audio signal 12 and display that number to the user on the display of the mobile device 20.

At the present time most mobile devices have their operating system and applications embedded within the device, but the next generation of mobile phones and personal digital assistants (PDAs) with wireless capability have the functionality to receive software upgrades and new applications to be run by the operating system. Therefore it is possible for a user to obtain the necessary software and store on it on their mobile device 20, so that the device 20 can retrieve the embedded telephone number from the audio signal 12.

As discussed above, with reference to the embodiment of FIG. 1, multiple telephone numbers can be communicated by the system, with or without additional information. In this embodiment, the mobile device 20, which is receiving the audio signal 12 that has been rebroadcast by the radio 24, can retrieve multiple embedded telephone numbers from the audio signal with any additional information that is present, The mobile device 20 can then display the numbers and the additional information, as appropriate, to the user. The mobile device 20 can store the telephone numbers and only display them on receipt of a predefined signal. When the broadcaster wishes to make the numbers available to the user, the predefined signal is sent in the audio signal 12 and this allows the synchronisation of multiple embedded telephone numbers with the correct portion of the radio broadcast.

FIG. 3 is a flow diagram of a communication method, showing the operation of the communication systems of FIGS. 1 and 2. As described above, the communication method in its simplest form comprises receiving 40 an audio signal 12, the audio signal 12 including an embedded telephone number, and outputting 46 the embedded telephone number.

Referring to the embodiment of FIG. 1, the method further comprises retrieving 42 the embedded telephone number from the audio signal 12, and the outputting 46 comprises broadcasting the embedded telephone number from a short-range wireless transceiver 14. In the embodiment of FIG. 2, the outputting 46 comprising broadcasting the embedded telephone number from an audio transmitter 26.

The communication method can further comprise storing 44 the embedded telephone number and outputting 46 the embedded telephone number on receipt of a predefined signal. The audio signal 12 can include multiple embedded telephone numbers and the outputting 46 can comprise outputting the multiple embedded telephone numbers.

FIGS. 4 and 5 refer to the operation of the embedding of the telephone numbers in the audio signal 12 by the broadcaster. A number of different methods of embedding information in signals are known, most of which rely on methods of adapting the signal in a predefined manner to carry supplemental information within the signal that is not readily apparent unless the recipient of the signal is aware of the use of the embedding. The recipient can then retrieve the information from the signal. Often the method of embedding involves lowering the data rate of the broadcast signal, with a slight but unnoticeable reduction in signal quality, and effectively “squeezing” in further information. U.S. Pat. No. 6,157,330 of US Philips Corporation describes a method of embedding supplemental data in an encoded signal, and is incorporated herein by reference.

At the broadcast end of the embedding system, the communication system comprises a multiplexer 50 for receiving an audio signal 12 and for embedding a telephone number in the audio signal 12, and also comprises a transmitter 52 for transmitting said audio signal. The multiplexer 50 can further receive a video signal 54, and the transmitter 50 transmits a digital television signal, with the telephone number embedded in the audio potion of the broadcast signal. The multiplexer 50 can embed a plurality of telephone numbers within said audio signal 12, and can also embed further information concerning the embedded telephone numbers within the audio signal 12. FIG. 5 shows a flow diagram of the steps of multiplexing 60 the signal and then transmitting 62 the audio signal 12.

The system used by the broadcaster can be either digital or analogue, in both cases it is a relatively simple matter to embed the telephone number or numbers within the audio portion of the television signal. Likewise, if the broadcast is a simple radio broadcast, then this can be a traditional analogue broadcast, or may be a digital system such as DAB. In the digital environment, some 48 bits can be encoded in 5 seconds without any audible deterioration of the audio signal 12. Thus in the ten seconds that it takes to speak a typical telephone number and for it to remain visible on a television screen, sufficient time is available to transfer the embedded telephone number to the receiving device. In the case of a radio broadcast, it is typical for the announcer to repeat the telephone number, again allowing sufficient time for the number to be transmitted as an embedded part of the audio signal 12. If a large amount of information is required to be embedded in the audio signal 12 over a relatively short period of time, then the data rate can be increased as the audio of the spoken voice can be degraded for a short period of time, without unduly affecting the listeners enjoyment of the programme. It is also possible to increase the data rate of the embedding when the sound is not critical, as a way of increasing the amount of information transmitted without degradation of the audio signal.

1. A communication system comprising a receiver for receiving an audio signal, said audio signal including an embedded telephone number, and an output device for outputting said embedded telephone number.

2. A system according to claim 1, wherein said output device is a short-range wireless transceiver.

3. A system according to claim 2, wherein said receiver is a digital television receiver and said output device is a separate unit connected to the SCART socket of the receiver.

4. A system according to claim 1, wherein said output device is an audio transmitter.

5. A system according to any preceding claim, and further comprising a mobile device for receiving the embedded telephone number from the output device.

6. A system according to claim 5, wherein said mobile device includes a short-range wireless transceiver.

7. A communication method comprising receiving an audio signal, said audio signal including an embedded telephone number, and outputting said embedded telephone number.

8. A method according to claim 7, and further comprising retrieving said embedded telephone number from said audio signal.

9. A method according to claim 8, wherein said outputting comprises broadcasting said embedded telephone number from a short-range wireless transceiver.

10. A method according to claim 8 or 9, and further comprising storing said embedded telephone number and outputting said embedded telephone number on receipt of a predefined signal.

11. A method according to claim 7, wherein said outputting comprises broadcasting said embedded telephone number from an audio transmitter.

12. A method according to any one of claims 8 to 11, wherein said audio signal includes multiple embedded telephone numbers and said outputting comprises outputting said multiple embedded telephone numbers.

13. A communication system comprising a multiplexer for receiving an audio signal and for embedding a telephone number in said audio signal, and a transmitter for transmitting said audio signal.

14. A system according to claim 13, said multiplexer for further receiving a video signal, and said transmitter transmitting a digital television signal, with said telephone number embedded in the audio potion of the broadcast signal.

15. A system according to claim 13 or 14, wherein said multiplexer embeds a plurality of telephone numbers within said audio signal.

16. A communication method comprising multiplexing a received audio signal, embedding a telephone number in said audio signal, and transmitting said audio signal.

17. A method according to claim 16, and further comprising multiplexing a received video signal, and transmitting a digital television signal, with said telephone number embedded in the audio potion of the broadcast signal.

18. A method according to claim 16 or 17, and further comprising embedding a plurality of telephone numbers within said audio signal.
